(19) United States
(12) Patent Application Publication
(10) Pub. No.: US 2007/0154681 A1
(43) Pub. Date: Jul. 5, 2007

(54) OPTICAL FILM DELIVERY UNIT

(76) Inventor: Hsin-Chin Lee, Chungli city (TW)

Correspondence Address: 3M INNOVATIVE PROPERTIES COMPANY, PO BOX 33427, ST. PAUL, MN, 55133-3427, US

(21) Appl. No.: 11/275,387

(22) Filed: Dec. 29, 2005

(51) Int. Cl. B32B 3/04

(52) U.S. Cl. 428/126

(57) ABSTRACT

An optical film delivery unit is comprised of an optical film strip having optical films protected by at least one liner. Scores, typically dot-line cuts, in the liners initiate folding. The optical film strip is folded along the scores such that the optical film delivery unit assumes a Z-fold structure that provides several advantages. There is no tension on the strip. The optical films do not create impressions on each other and remain flat. In addition, the optical film unit is relatively small making it more efficient to package and transport.

### BACKGROUND OF THE INVENTION

The present invention relates to optical films. In particular, the present invention relates to delivery formats of optical films.

Optical displays, such as backlit liquid crystal displays (LCDs), are used in a wide variety of applications including mobile telephones, personal digital assistants (PDAs), electronic games, laptop computers, monitors and television screens. Optical films are stacked within an optical display in order to enhance brightness and improve display performance without sacrificing battery life.

Currently, individual optical films are placed between protective layers, which are then wound around a reel. Several issues result from using the reel format for delivery of optical films. First, tension is placed on the strip as it is wound in order to create a tightly wound reel. As a result of the increased tension along with the weight of the material itself, optical films layered adjacent to each other around the reel may leave impressions on each other. In addition, the optical films tend to curl when removed from the protective liners. Resolving these problems would reduce damage to the optical films.

### BRIEF SUMMARY OF THE INVENTION

The present invention is an optical film delivery unit and a method of making the optical film delivery unit. Optical films are on a liner, which is scored and folded such that the optical film delivery unit assumes a Z-fold structure. The Z-fold structure has at least one fold and a plurality of pages.

### BRIEF DESCRIPTION OF THE DRAWINGS

FIG. 1 is a front view of a representative embodiment of the optical film delivery unit.

FIG. 2 is a top view of a representative embodiment of the optical film strip.

FIG. 3 is a schematic illustration of a representative embodiment of the method of making the optical film delivery unit.

### DETAILED DESCRIPTION

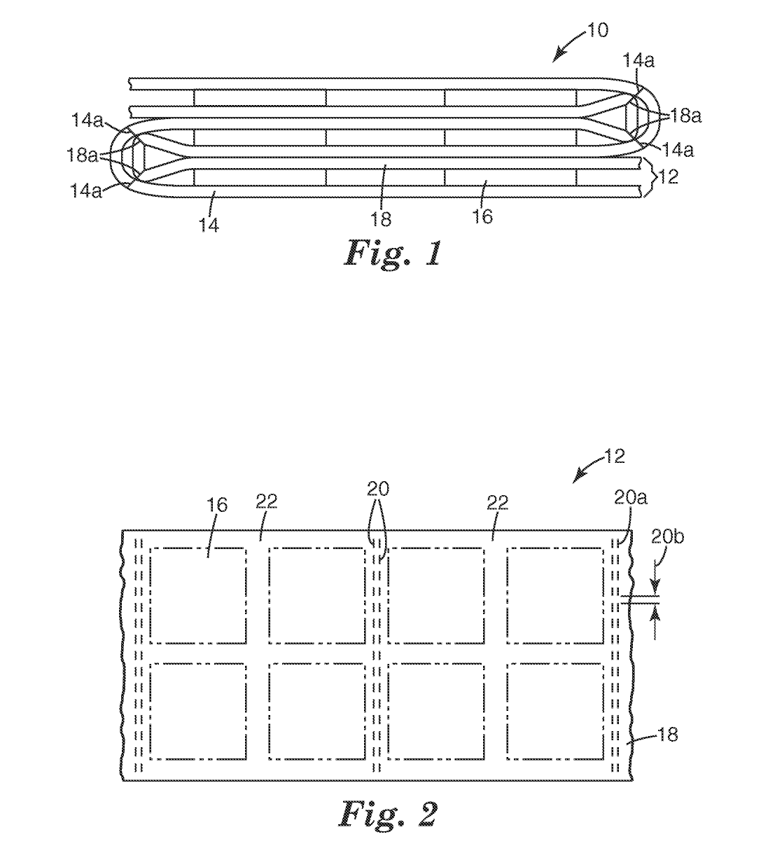

FIG. 1 shows a representative embodiment of optical film delivery unit 10. Unit 10 includes optical film strip 12 with liner 14, optical films 16, which may be light directing films, diffuser-type films, turning films, multi-layer polymer films, reflective films, etc. and liner 18. Liner 14 includes folds 14a, and liner 18 includes folds 18a. Optical films 16 are placed between liners 14 and 18. Liners 14 and 18 fold at folds 14a and 18a, respectively, such that unit 10 forms a Z-fold (accordion fold, zig-zag fold) structure.

Liners 14 and 18 are protective coverings for films 16 and may be composed of identical or different materials. Optical films 16 are held between liners 14 and 18 by any of a number of ways, such as, for example, adhesive tapes or adhesive coatings.

It should be noted that unit 10 could also be formed using only one liner. For example, unit 10 may include only liner 14 and optical films 16. Folding liner 14 at folds 14a produces a Z-fold structure where both surfaces of liner 14 protect optical films 16.

As discussed above, current delivery formats for optical film strip 12 include winding strip 12 around a reel. Unit 10 provides several advantages over the reel format. Because strip 12 is not wound around a reel, there is no winding tension, which subsequently alleviates impressions that result from optical films layered adjacent to each other. Optical films 16 no longer curl when removed from strip 12, because strip 12 is not wound. The overall volume of unit 10 is reduced by between about 20% and about 40% compared to the reel format. In addition, unit 10 is easily set up on a working table to remove liners 14 and 18 for assembly of optical film 16 into an optical display, and unit 10 is easy to package and transport.

FIG. 2 is a representative embodiment of optical film strip 12. Optical film strip 12 includes optical films 16 (shown in phantom), liner 18, dot-line cuts 20 with cuts 20a and gaps 20b, and pages 22. Dot-line cuts 20 define pages 22 and define placement of folds 14a and 18a, shown in FIG. 1, by scoring liners 14 and 18. Dot-line cuts are only one example. Any of a number of types of scores, which are known in the art, besides dot-line cuts may also be used to define placement of folds.

As shown, dot-line cuts 20 typically extend in parallel lines across most of the width of strip 12. Tension may be placed on strip 12 while liners 14 and 18 are removed from optical films 16. In order to prevent splitting along dot-line cuts 20 when tension is placed on strip 12, dot-line cuts 20 end at least about 0.5 mm from the edges of liners 14 and 18.

Depending on the thickness of strip 12, cuts 20a of dot-line cuts 20 vary in length between about 0.5 mm and 30 mm. Typically, the length of cuts 20a is between about 1.0 mm and about 2.0 mm. Generally, the length of cut 20a increases as the thickness of strip 12 increases. Gap 20b, which is the spacing between each cut 20a, has a length between about 0.5 mm and about 30 mm. Typically, gap 20b has a length of about 1.0 mm.

Using two dot-line cuts 20 to define pages 22 usually allows pages 22 of strip 12 to lay flat when strip 12 is in a Z-fold structure. This is illustrated in FIG. 1. Depending on the thickness of strip 12, more dot-line cuts 20 may be used to define pages 22, however, one dot-line cut 20 may also be used if desired. Less typically, strip 12 can be folded into unit 10 without dot-line cuts 20, but this would not be as efficient or accurate.

Depending on the number of dot-line cuts 20 used between pages 22 and the thickness of strip 12, each set of dot-line cuts 20 is spaced between about 0.1 mm and about 1.0 mm. Typically, spacing between dot-line cuts is greater than the thickness of strip 12. In addition, each page 22 of strip 12 will generally be of equal size, although this is not required. The size of pages 22 will vary and depends upon the size of optical films 16 and the number of optical films 16 on each page 22.

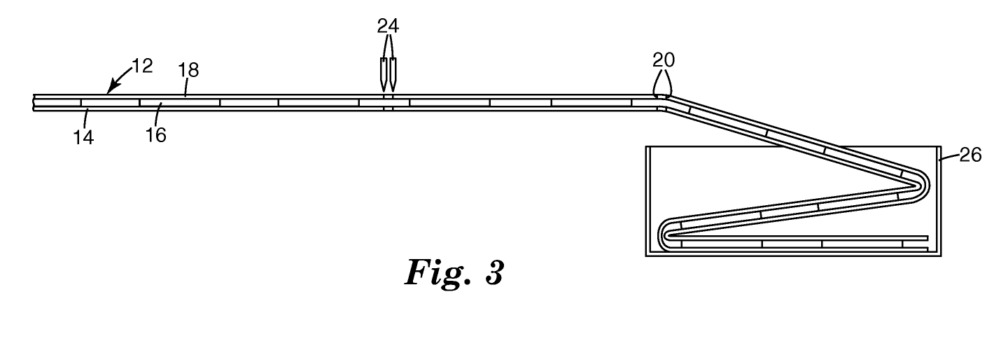

FIG. 3 is a representative embodiment of a method of making optical film delivery unit 10. FIG. 3 includes strip 12 with liner 14, optical films 16 and liner 18; dot-line cuts 20; blades 24 and collector 26.

To produce unit 10, blades 24 cut through liners 14 and 18 to form dot-line cuts 20 at predetermined intervals along strip 12. Strip 12 is then fed into collector 26 where it folds along dot-line cuts 20 to form a Z-fold structure. Unit 10 is subsequently packaged and shipped to a manufacturer for assembling optical films 16 into a display.

Use of unit 10 instead of a reel does not require any special equipment or treatment by the manufacturer. Upon delivery to the manufacturer, strip 12 of unit 10 is fed into a dispenser to remove liner 14 and/or liner 18 from optical films 16. Removal of liners 14 and 18 entails peeling back these layers from optical films 16 in opposing directions. The same equipment and process are used for the current reel format. Optical films 16 are then either manually or automatically placed into an optical display.

Optical film delivery unit 10 provides several advantages over the current reel format for packaging and dispensing optical films. Unit 10 alleviates winding tension within strip 12 and impression and curl issues of optical films 16. Unit 10 has a reduced volume compared to the reel format making it easy to package and transport.

Although the present invention has been described with reference to preferred embodiments, workers skilled in the art will recognize that changes may be made in form and detail without departing from the spirit and scope of the invention.

We claim:

1. An optical film delivery unit comprising:
a liner having at least one score; and
a plurality of optical films on the liner, the optical films and liner forming an optical film strip;
wherein the liner is folded along the score such that the optical film delivery unit assumes a Z-fold structure having a plurality of pages.

2. The optical film delivery unit of claim 1 and further comprising:
first and second scores between each page.

3. The optical film delivery unit of claim 2 wherein a distance between the first and second scores is greater than a thickness of the optical film strip.

4. The optical film delivery unit of claim 2 wherein the scores between each page are parallel and separated by a distance of between about 0.1 mm and about 1.0 mm.

5. The optical film delivery unit of claim 1 wherein the score is a dot-line cut.

6. The optical film delivery unit of claim 3 wherein cuts of the dot-line cut have a length between about 0.5 mm and about 30 mm, and a gap between the cuts has a length between about 0.5 mm and 30 mm.

7. The optical film delivery unit of claim 1 wherein the score stops at least about 0.5 mm from edges of the liner.

8. The optical film delivery unit of claim 1 wherein the optical films are at least one of light directing films, diffuser-type films, turning films, multi-layer polymer films and reflective films.

9. An optical film delivery unit comprising:
an optical film strip comprised of a plurality of optical films between liners, the optical film strip having at least one dot-line cut and being folded along the dot-line cut such that the optical film strip has a plurality of pages and at least one fold.

10. The optical film delivery unit of claim 9 wherein each page includes at least one optical film.

11. The optical film delivery unit of claim 9 and further comprising:
a plurality of dot-line cuts defining each page on the optical film strip.

12. The optical film delivery unit of claim 11 wherein a distance between dot-line cuts is greater than a thickness of the optical film strip.

13. The optical film delivery unit of claim 9 wherein the dot-line cut stops at least about 0.5 mm from edges of the liner.

14. The optical film delivery unit of claim 9 wherein cuts of the dot-line cut have a length between about 0.5 mm and about 30 mm and are spaced between about 0.1 mm and about 1.0 mm apart.

15. A method of making an optical delivery unit, the method comprising:
forming at least one score in an optical film strip comprised of a plurality of optical films between liners; and
folding the optical film strip along the score such that the optical film delivery unit has a plurality of pages and at least one fold.

16. The method of claim 15 wherein the score is a dot-line cut.

17. The method of claim 16 wherein two parallel dot-line cuts are formed between each page.

18. The method of claim 17 wherein the two parallel dot-line cuts are separated by a distance between about 0.1 mm and about 1.0 mm.

19. The method of claim 16 wherein cuts of the dot-line cut have a length between about 0.5 mm and 30 mm and are spaced between about 0.5 mm and about 30 mm apart.

20. The method of claim 15 wherein the optical films are at least one of light directing films, diffuser-type films, turning films, multi-layer polymer films and reflective films.
